(19) United States
(12) Patent Application Publication
(10) Pub. No.: US 2012/0109418 A1
(43) Pub. Date: May 3, 2012

(54) DRIVER PROFILING

(75) Inventor: Amir Lorber, Bnei Brak (IL)

(73) Assignee: TRACKTEC LTD., Bnei Brak (IL)

(21) Appl. No.: 13/382,367

(22) PCT Filed: Jul. 7, 2010
(86) PCT No.: PCT/IL2010/000547

§ 371 Date: Jan. 5, 2012

Related U.S. Application Data
(60) Provisional application No. 61/223,379, filed on Jul. 7, 2009.

(51) Int. Cl. G06F 7/00

(52) U.S. Cl. 701/1

(57) ABSTRACT

The present invention discloses a driver profiling system comprising: at least one sensor adapted to measure vehicle parameters; computing means in communication with said sensors, provided with storage means adapted to store said vehicle parameters, and provided with means for issuing warnings based on said vehicle parameters; a remote server adapted to receive, store, analyze, and display said vehicle parameters; and, communication means adapted to transfer said vehicle parameters and associated data to said remote server; whereby historical vehicle parameter data may be analyzed to identify driver characteristics.

### FIELD OF THE INVENTION

The present invention relates to a system for driver profiling, useful for fleet managers, trucking supervisors, insurance professionals, and the like.

### BACKGROUND OF THE INVENTION

In the prior art a variety of systems for fleet management have been proposed. For example, U.S. Pat. No. 7,489,993 provides a vehicle fleet management information system for identification of location and direction of vehicle movement that detects given events of interest and reports information to a fleet management office, over communications network. The status of predetermined events in which the vehicle is engaged (such as loading, unloading, etc) is reported directly to the fleet manager. However this system does not characterize the drivers in terms of their safety, time efficiency, fuel efficiency, or the like.

US patent application US20040236596A1 discloses a business method for a vehicle safety management system. This method is based on detecting safe driving behavior in a vehicle, by processing vehicle data for parameters associated with movement of the vehicle, then processing vehicle data to determine whether movement of vehicle meets one or more preset condition. The Vehicle Safety Management System (“VSM”) can detect a plurality of unsafe driving events, including tailgating, frequent lane changes, speed limit violation, and speed limit violation over a curved segment of road, rapid acceleration from a start, and rapid deceleration to a stop. The vehicle is equipped with an event detection module. The event detection module includes a circuit that acquires vehicle data for parameters associated with movement of the vehicle. The event detection module also includes a processor for executing algorithms that determine whether movement of the vehicle meets one or more pre-determined conditions. If the pre-determined conditions are met, event data for one or more unsafe driving events are generated. The event detection module includes a transceiver to send and receive data between the vehicle and a server. The server presents event data to a customer so as to allow the customer to view unsafe driving behavior data for the customer's fleet. For example, the application server may generate reports that detail the unsafe driving events for a driver, vehicle, condition, etc. US patent application 20040236474A1, 20040236475A1, and 20040236475A1 present similar systems. While able to characterize the drivers in terms of their safety, there is no provision here for characterization of drivers in terms of time efficiency, fuel efficiency, or the like.

U.S. Pat. No. 6,772,055 provides a vehicle action supervisory computer with a behavioral rule network that is easily modified by the operator e.g. in an aircraft or automobile, via interface with screen, loudspeaker, microphone and keyboard. The invention concerns a system for generating decisions concerning the behavior of a vehicle and/or of a driver of a vehicle. The system comprises a supervising unit which comprises at least one storage member. In the storage member there is a set of rules of a particular kind for how the driver of the vehicle and/or the vehicle shall behave in different situations. The system also comprises a user interface and adaptation means arranged to adapt said set of rules such that at least some of the rules with conclusions belonging thereto are suited to form the basis for decisions concerning the behavior of a vehicle and/or of a driver of a vehicle. This system is a prescriptive rather than descriptive one, generating rules for behavior as opposed to observations of behavior. Thus it is not adapted for providing a profile of drivers of vehicles.

U.S. Pat. No. 6,278,362 provides a driving state-monitoring apparatus for automotive vehicles consisting of a parameter detector, speed detector, reference behavior parameter setting device, lateral deviation computer, driving state determination device, and abnormality determination device. These devices are adapted to detect various states such as yawing movements, lateral movements of the automotive vehicle, and vehicle speed of the automotive vehicle. It is determined whether or not the driving state of the driver is normal, based on the lateral deviation behavior amount. Responsive to a determination that the driving state of the driver is not normal, it is determined that the driving state of the driver is abnormal, and a warning is given to the driver and/or a vehicle speed reduction is effected. This system is designed for delivery of warnings in cases of dangerous or aberrant driving or situations, and is not adapted to provide, record, or transmit driver profiles.

PCT patent application WO2007077867A1 provides a drive behavior estimating device, drive supporting device, vehicle evaluating system, driver model making device, and drive behavior judging device.

Vehicle driving action estimation apparatus has maximum post event probability calculation unit that calculates probability distribution against feature value which is acquired in time series, for generating driver model.

A driver model with higher accuracy is made as a reference of evaluation of a normal driving state and a drive behavior is estimated. While the driver is driving, data on the driving state (data on the vehicle such as accelerator depression, brake depression, steering amount, vehicle speed, distance to another vehicle, acceleration) is collected. From the driving state data, data on the driver's normal driving state is extracted, and a normal driver model is automatically made. By means of a certain mathematical modeling technique, a driver model of each driver can be simply made. Further, by performing computation maximizing the conditioned probability, a drive operation behavior can be easily estimated and outputted.

U.S. Pat. No. 6,894,606 provides a vehicular “black box” with recording means by which driver action can be reviewed after an accident or collision, as well as indicating immediate vehicle disposition status to the driver. Using cameras (which may be very small), the disposition of the vehicle in its lane is determined by detecting the highway lines painted on the road. This device records actions for post-collision analysis and is not adapted to provide periodically updated information regarding driver behavior.

U.S. Pat. No. 5,499,182 provides a vehicle driver performance monitoring system. A plurality of vehicle component sensors suitably mounted to a host vehicle measure a plurality of vehicle component parameters indicative of the host vehicle's driver performance. A microprocessor module detachably coupled to the vehicle mounting unit affixed to and uniquely designated for a given host vehicle polls each vehicle sensor to read, process, and store the vehicle operation data generated thereby. A playback mounting unit is provided to facilitate the connection of a remote computer to the host vehicle's microprocessor module in order to establish digital communication whereby the vehicle operation data and the analysis results processed therein are retrieved and displayed for a user. However no clear provision is made for the analysis of the collected information into usable information. To provide a coherent profile of driver behavior, statistical analyses of a driver's actions and comparison of these actions to population averages are clearly useful improvements over the system provided in '182.

Hence, an improved method of driver profiling is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a vehicle equipped with sensors and data transmission means;

FIG. 2 presents an acceleration-based data information display for driver profiling;

FIG. 3 presents a camera-based summary information display for driver profiling;

FIG. 4 presents a single driver Safety Stars report based on fleet average (sample);

FIG. 5 presents a fleet Safety Stars summary report (sample); and

FIG. 6 presents interactive display and information transmission device.

FIGS. 7a-b present a steering wheel with sensors embedded therein.

### SUMMARY OF THE INVENTION

The present invention comprises a system and method for driver profiling. It is within the core of the present invention to provide a driver profiling system comprising:
a. at least one sensor adapted to measure vehicle parameters;
b. computing means in communication with said sensors, provided with storage means adapted to store said vehicle parameters, and provided with means for issuing warnings based on said vehicle parameters; and,
c. a remote server adapted to receive, store, analyze, and display said vehicle parameters;
d. communication means adapted to transfer said vehicle parameters and associated data to said remote server;
   whereby historical vehicle parameter data may be analyzed to identify driver characteristics.

It is further within provision of the invention to provide the aforementioned system, further comprising a display means within said vehicle adapted to display a plurality of parameters to said driver, said parameters selected from a group consisting of: acceleration level, deceleration level, headway distance, lane departure warning, fuel efficiency, time efficiency, and driving status.

It is further within provision of the invention to provide the aforementioned system, where said driver characteristics are evaluated by determining a driver score D for every driver, based on frequencies Ci of driving events i, with

$$D = {\sum }_{i}^{ } {G}_{i} ( {C}_{i} ) \times {S}_{i}$$

with Si being a set of weights, and the Gi being functions of said frequencies Cᵢ.

It is further within provision of the invention to provide the aforementioned system, where said driver score is used to determine a number of ‘safety stars’ said safety stars being a rating on a scale of 1-5 stars.

It is further within provision of the invention to provide the aforementioned system, wherein said driving events are selected from a group consisting of: lane departures, accelerations, decelerations, insufficient headway, insufficient clearance, signal use, lack of signal use during turns, and velocity excursions.

It is further within provision of the invention to provide the aforementioned system, where said at least one sensor is selected from a list consisting of steering wheel position sensor, wheel angle sensor, gas pedal position sensor, brake pedal position sensor, brake pad position sensor, clutch pedal position sensor, clutch position sensor, vehicle velocity sensor, acceleration sensor, position sensor, wheel rpm sensor, engine rpm sensor, gear shift position sensor, external light level sensor, vehicle light condition sensor, video cameras, neighboring car proximity sensor, neighboring car velocity sensor, neighboring object proximity sensor, neighboring car velocity sensor, wind velocity sensor, rainfall rate sensor, road condition, sensor, tilt sensor, roll sensor, yaw sensor, cabin noise level sensor, cabin audio signal sensor, gas tank fuel level sensor, and speed limit sensor.

It is further within provision of the invention to provide the aforementioned system, wherein said sensor is adapted to provide information relating to at least one selection from a group consisting of the steering wheel hold, the time function of the steering wheel hold, amount of pressure applied on the brake system, the amount of times the brake system is pressed, the road conditions, the amount of times the driver had changed lanes to pass another vehicle on the road is counted, distance being kept from neighboring vehicles, seat belt wear, driver fatigue, visibility conditions, amount of outside light, humidity, weather or any combination thereof.

It is further within provision of the invention to provide the aforementioned system, using a video camera, where said computing means is provided with image processing means adapted to identify events and parameters selected from a group consisting of: lane departures, neighboring cars, trucks, motorcycles, mopeds, bicycles, pedestrians, and amount of headway.

It is further within provision of the invention to provide the aforementioned system, where said warnings are selected from a list consisting of: lane departures warnings, headway warnings, and forward collision warnings.

It is further within provision of the invention to provide the aforementioned system, where said remote server is adapted to present histograms of driver performance data and histograms of average driver performance data.

It is further within provision of the invention to provide the aforementioned system, further is providing driver feedback in the form of indicators displaying acceleration information and status information.

It is within provision of the invention that a display be provided within the vehicle that indicates to the driver and/or occupant one or more parameters such as acceleration/deceleration level, distances to near objects or lanes, overall ‘driving status’ and the like.

It is another object of the present invention to provide a method for driver profiling the method comprising inter alia steps of
a. providing at least one sensor adapted to measure vehicle parameters;
b. providing computing and storage means in communication with said sensors;
c. measuring vehicle parameters by means of said sensors;
d. storing said measurements by means of said storage
e. issuing warnings based on said vehicle parameters;
f. providing a remote server adapted to analyze said vehicle parameters;
g. communicating said vehicle parameters to said remote server;
h. receiving, storing, analyzing, and displaying said vehicle parameters on said remote server;
   whereby historical vehicle parameter data may be analyzed to identify driver characteristics.

It is another object of the present invention to provide the method as described above, further providing display means within said vehicle adapted to display a plurality of parameters to said driver, said parameters selected from a group consisting of: acceleration level, deceleration level, headway distance, lane departure warning, fuel efficiency, time efficiency, and driving status.

It is another object of the present invention to provide the method as described above, further determining a driver score D for every driver, based on frequencies Ci of driving events i, with

$$D = {\sum }_{i}^{ } {G}_{i} ( {C}_{i} ) \times {S}_{i}$$

with Si being a set of weights, and the Gi being functions of said frequencies Cᵢ.

It is another object of the present invention to provide the method as described above, where said driving events are selected from a group consisting of: lane departures, accelerations, decelerations, insufficient headway, insufficient clearance, signal use, lack of signal use during turns, and velocity excursions.

It is another object of the present invention to provide the method as described above, where said driver score is used to determine a number of ‘safety stars’ said safety stars being a rating on a scale of 1-5 stars.

It should be emphasized that the present invention is not limited to the above described rating system and any rating on a scale of any given number of stars can be used. Furthermore, the star symbol or any other symbol can be used.

It is another object of the present invention to provide the method as described above, additionally comprising step of selecting said at least one sensor from a list consisting of steering wheel position sensor, wheel angle sensor, gas pedal position sensor, brake pedal position sensor, brake pad position sensor, clutch pedal position sensor, clutch position sensor, vehicle velocity sensor, acceleration sensor, position sensor, wheel rpm sensor, engine rpm sensor, gear shift position sensor, external light level sensor, vehicle light condition sensor, video cameras, neighboring car proximity sensor, neighboring car velocity sensor, neighboring object proximity sensor, neighboring car velocity sensor, wind velocity sensor, rainfall rate sensor, road condition, sensor, tilt sensor, roll sensor, yaw sensor, cabin noise level sensor, cabin audio signal sensor, gas tank fuel level sensor, and speed limit sensor.

It is another object of the present invention to provide the method as described above, using a video camera, where said computing means is provided with image processing means adapted to identify events and parameters selected from a group consisting of: lane departures, neighboring cars, trucks, motorcycles, mopeds, bicycles, pedestrians, and amount of headway.

It is another object of the present invention to provide the method as described above, additionally comprising the step of selecting said warnings from a list consisting of: lane departures warnings, headway warnings, and forward collision warnings.

It is another object of the present invention to provide the method as described above, where said remote server is adapted to present histograms of driver performance data and histograms of average driver performance data.

It is another object of the present invention to provide the aforementioned method, where the method additionally comprises an optional step of providing information relating to at least one of the following: (a) the steering wheel hold; (b) the time function of the steering wheel hold; (c) the amount of pressure applied on the brake system; (d) the amount of times the brake system is pressed; (e) the road conditions; (f) the amount of times the driver had changed lanes to pass another vehicle on the road; (g) the distance being kept from neighboring vehicles; (h) seat belt wear; (i) driver fatigue; (j) visibility conditions; (k) amount of outside light; (l) humidity; (m) weather or any combination thereof.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a system and method for driver profiling.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g., 1, 5, or 10.

According to a preferred embodiment of the present invention, a system of sensors is implemented in a vehicle in order to monitor the actions of the driver, actions of other drivers, conditions of the road, and associated data. These sensors consist, for example, of sensors for steering wheel position, wheel angle, gas pedal position, brake pedal position, brake pad position, clutch pedal position, clutch position, vehicle velocity, acceleration, position, wheel rpm, engine rpm, gear shift position, external light level, vehicle light condition, video cameras, neighboring car proximity and velocity, neighboring object proximity and velocity, wind velocity, rainfall rate, road condition, tilt, roll, yaw, cabin noise level, cabin audio signal, gas tank fuel level, speed limit and the like.

According to another embodiment of the present invention, the sensors are adapted to provide information relating to the steering wheel hold and the time function of the steering wheel hold. In other words, the sensors are adapted to indicate if the driver is holding the steering wheel, if the driver is holding the steering wheel in both hands (a firm hold) one hand (minor hold) or if the driver is not holding the steering wheel at all, the time function of the steering wheel hold (i.e., the amount of time the driver is holding the wheel with two hands, one hand, no hands at all). Preferably the sensors are positioned on the steering wheel, however any position can be used.

According to a specific embodiment of the present invention the following events are recorded:
1. If the vehicle is turning and the driver is holding the steering wheel using one hand.
2. If the vehicle's velocity is above a predetermined value and the driver is holding the steering wheel using one hand.
3. If the vehicle's velocity is above a predetermined value for a predetermined amount of time.
4. If the steering wheel is turned when the hand grip is incorrect.

5. A tight grip of the steering wheel (i.e., application of pressure on the same which is above a predetermined value)—can indicate an insecure driver or a stressed driver.

The variation of the steering wheel hold vs. time can also be taken into consideration in the analysis of the driver characteristics.

According to another embodiment of the present invention, the sensors are adapted to detect the amount of pressure applied on the brake system, the amount of times the brake system is pressed. As described above, such information can be taken into consideration in the analysis of the driver characteristics.

According to another embodiment of the present invention, the road conditions (e.g., road bumpiness, road moisture, road curvature) are sensed and taken into consideration in the analysis of the driver characteristics.

According to another embodiment of the present invention, the outside light, humidity, weather or any combination thereof are also sensed.

According to another embodiment of the present invention, the amount of times the driver had changed lanes to pass another vehicle is counted. Said amount is taken into consideration and can influence the analysis of the driver characteristics.

According to another embodiment of the present invention, the distance being kept from the vehicle in front (i.e., from neighboring vehicles) is taken into consideration in the analysis of the driver characteristics.

According to another embodiment of the present invention, sensors are provided so as to provide information as for whether or not the driver is wearing a seat belt. Furthermore, such information can be analyzed as a function of time (if the driver had worn a seat belt or not, for how long did the driver wear or not wear the seat belt et cetera). Again, such information can be taken into consideration in the analysis of the driver characteristics.

According to another embodiment of the present invention, sensors (namely cameras) are provided so as to provide information as to how many times (if at all) did the driver take his/her eyes off the road and for how long. Again, such information can be taken into consideration in the analysis of the driver characteristics.

According to another embodiment of the present invention, fatigue is being sensed. According to this embodiment, sensors (namely cameras) are provided so as to provide information as to how exhausted or weary the driver is.

According to another embodiment of the present invention, sensors are provided so as to provide information as to the visibility conditions.

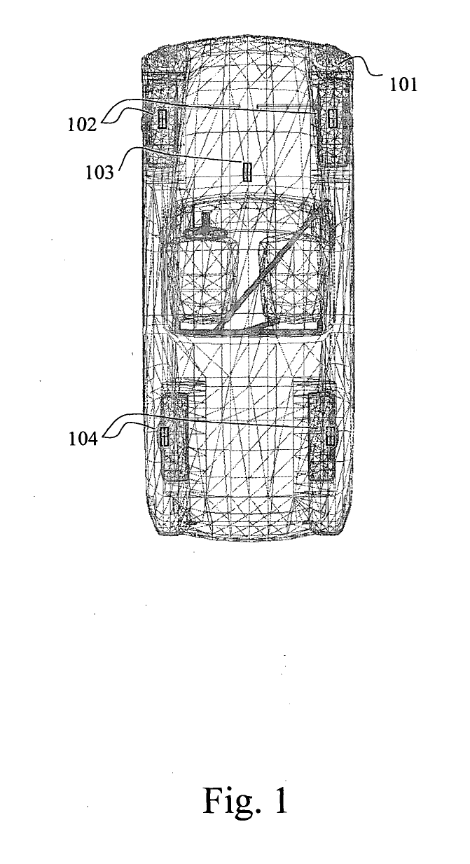

These sensors are connected to processing and storage means such as a digital microprocessor, on which the sensor data is integrated, processed, displayed, stored, and sent to remote locations. For example, in FIG. 1 a vehicle 101 is shown provided with a plurality of sensors 102 and 104, and a microprocessor 103. The sensors 102 in this case may be wheel angle sensors adapted to measure the wheel angle with respect to the direction of the car's travel. Sensors 104 may be wheel speed detectors, adapted to measure the exact ground speed of the vehicle. By continuous measurement and storage of such sensors, a rather complete profile of the driver's behavior can be accumulated. For example, the speed sensors 104 when combined with clock data can be used to provide measures of acceleration, or independent accelerometers can be used. In either case, by means of long-term measurement of acceleration, statistical measures of the driver's behavior can be provided.

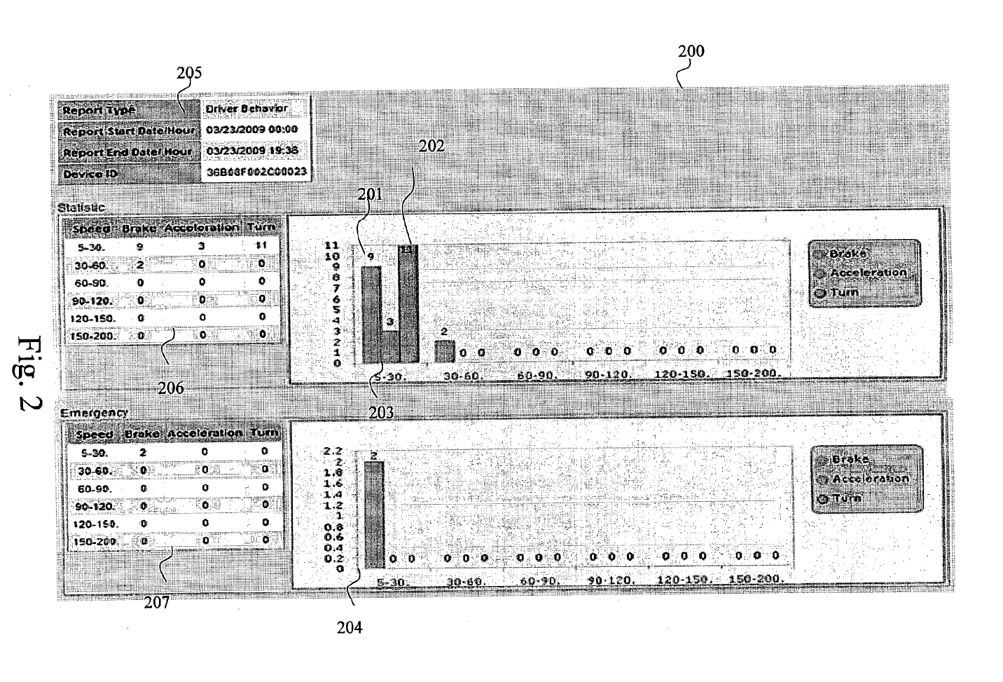

An example of such statistical information gathering is shown in FIG. 2. Here, a GUI is shown that provides a concise report summarizing driver history over some time period. In this case three parameters have been measured: turning speed, brake use, and acceleration. Histograms showing these parameters have been constructed; the brake histogram 201 shows 9 cases between 5-30 (obviously the units for such displays may be chosen to conform to a particular unit system) while 2 cases fell between 30 and 60. Acceleration histogram 203 shows 3 cases of between 5-30, and turn histogram shows 11 cases between 5 and 30. In the bottom panel the ‘emergency brake’ cases are more carefully presented, in a histogram 204 with expanded y-scale. Auxiliary information is provided in the box 205 which displays the report type, start time, end time, and device ID. The history data is presented in tabular form in tables 206, 207.

It should be appreciated that the particular use of camera and computer with image processing means allows for relatively sophisticated analyses of a given traffic situation can be undertaken. For example, by mounting a high resolution video camera on or near the rearview mirror, the camera can be provided a view of the scene in front of the vehicle, similar to the view of the driver. By use of sufficiently powerful image processing equipment, such as an application-specific integrated circuit, the image may be analyzed to segment such features as other cars, pedestrians, median lines, reflectors, edge-of-road indicators, and the like. It will be appreciated that video information from a camera can be used to provide a wealth of data, such as indication of the speed limit, by means of appropriate image processing of video recorded.

It is within provision of the invention that based on information gathered by the various sensors of the system, warnings be provided to alert the driver that a potentially dangerous situation is developing. For example, if a driver attempts a lane change when another vehicle is in his blind spot, proximity detectors on the rear bumper will sense the proximity of the unseen car, and collision detecting algorithms (which will combine proximity and relative speed data) will issue an alert signal if a collision is deemed sufficiently imminent. This may take the form of an ‘expected time of collision’ calculation, where the distance between the driver's vehicle and a foreign body (such as another vehicle, wall, pedestrian, etc.) is calculated based on the relative speed between the two objects and the distance between them. If this time is less than a certain threshold, an alert may be issued. This alert may consist of an audible tone or other sound, visible signal, or other warning device. Various types of warnings may be issued, such as lane departure warnings, insufficient headway warnings, and forward collision warnings. Systems to provide such warnings based (for instance) on video data are known from e.g. U.S. Pat. No. 7,151,996 and are incorporated herein by reference.

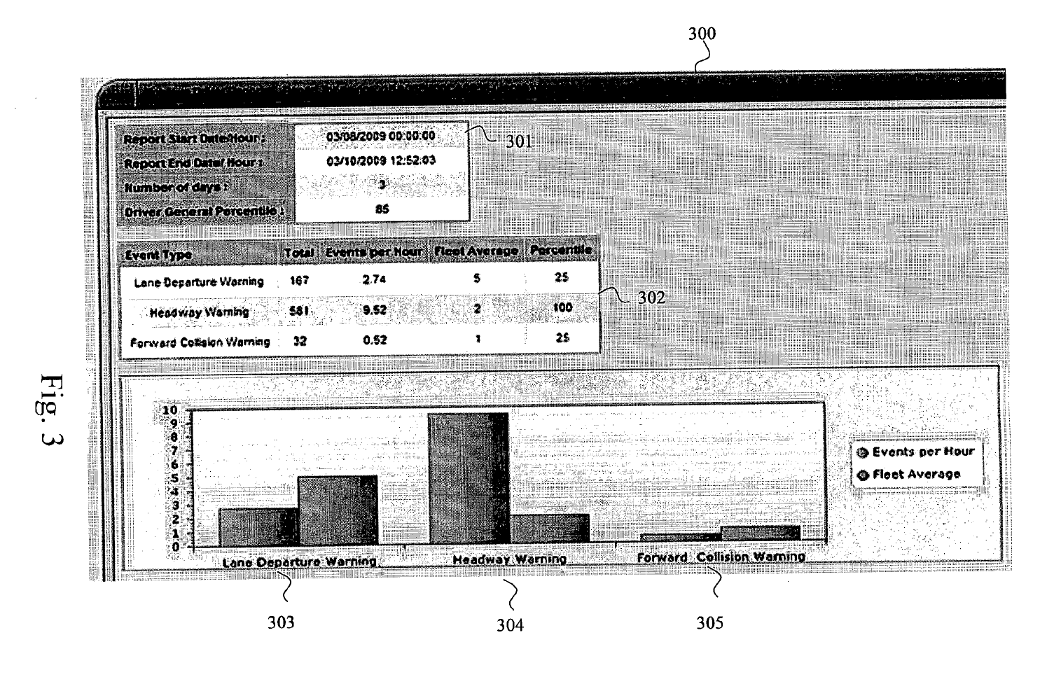

Beside presentation of data concerning a single driver, it is within provision of the current invention to provide statistical analyses based on fleet data and averages. In the GUI of FIG. 3, a window 300 provides comparison of individual to average behavior. Frequency histograms 303,304,305 show the frequency of various warnings issued—lane departure warnings 303, headway warnings, 304, and forward collision warnings 305. These are displayed as per-hour values, for an individual driver and for the fleet average. Auxiliary information is shown as before in box 301, while the summarized information is tabulated in table 302. By means of such tables, individual performance can be compared to fleet averages, and outstanding or extremely poor performance, for instance, can be identified easily.

It is within provision of the invention to identify driver safety by means of the accumulated data recorded by the system. For instance, a driver who receives an especially low rate of warnings may be identified as a safe driver, while one who receives a high rate of warnings may be identified as an unsafe driver. Obviously other parameters may be included in this estimation, such as the average distance kept between a driver's vehicle and the vehicle in front of it.

It is within provision of the invention that the time efficiency of a given driver be measured. This can be done for instance by finding an average speed of the driver, or by finding the average difference between the driver's speed and the maximum allowed speed. Obviously these definitions can be extended and improved, for example by taking into account traffic jams, rainy weather, road conditions, and the like.

It is within provision of the invention that the fuel efficiency of a given driver be measured. This may be accomplished by measuring fuel consumption vs. distance traveled, or by measuring the standard deviation of driver speed. This latter may be useful to identify forward-thinking drivers who realize, for example, that they will have to slow at a certain point, and instead of arriving at high speed and slowing suddenly, instead slow their speed gradually in the expectation that road conditions (such as stoplights) may have cleared if more time is spent before reaching the obstruction. In this way a large deceleration and consequent fuel waste is avoided.

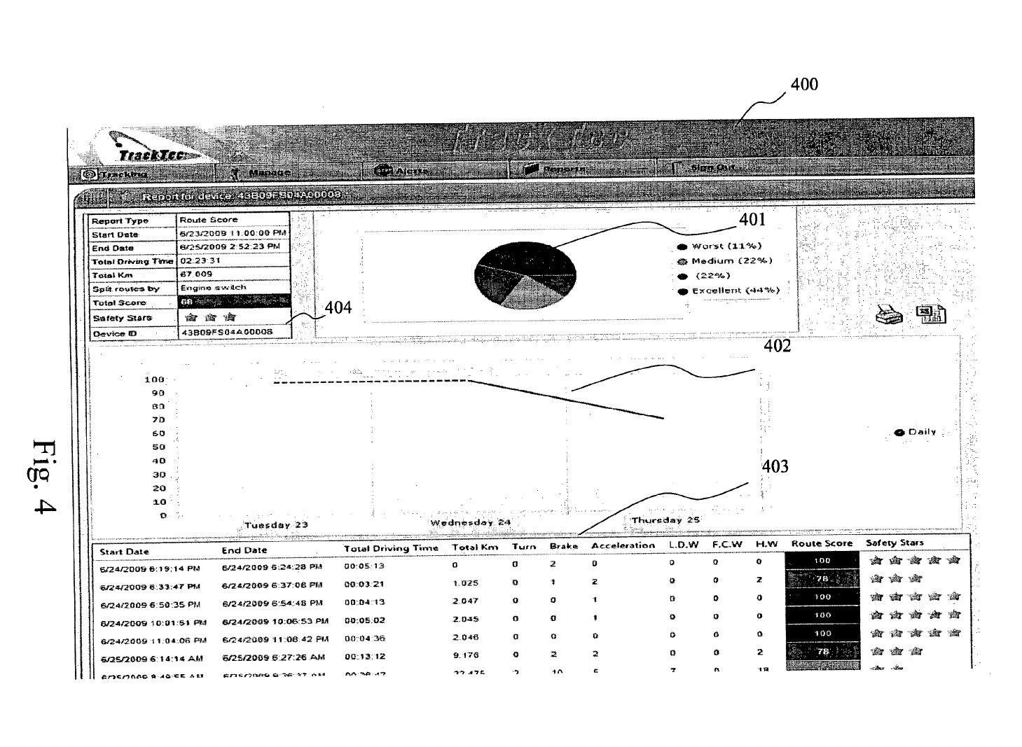

It is within provision of the system herein disclosed to rate a given driver, for example by a rating out of a maximum of five stars. In FIG. 4 a summary report 400 for a given driver using such a system (which we have named the Safety Stars™ program) is shown. Here a pie chart 401 is shown showing the distribution of drivers over different ranges of performance. This performance is related to the star rating and will be explained in detail below. A graph of performance as rated on a scale of 0-100 is shown in the center 402 of the summary report. Statistics for each separate driving leg is shown in the list 403, including driving time, kilometers travelled, and statistics for turning, braking, acceleration, and other parameters. Based on these parameters the driver's score on the 0-100 scale is calculated, from which a “Safety Star”™ rating is given (for example by dividing the 0-100 scale into quintiles).

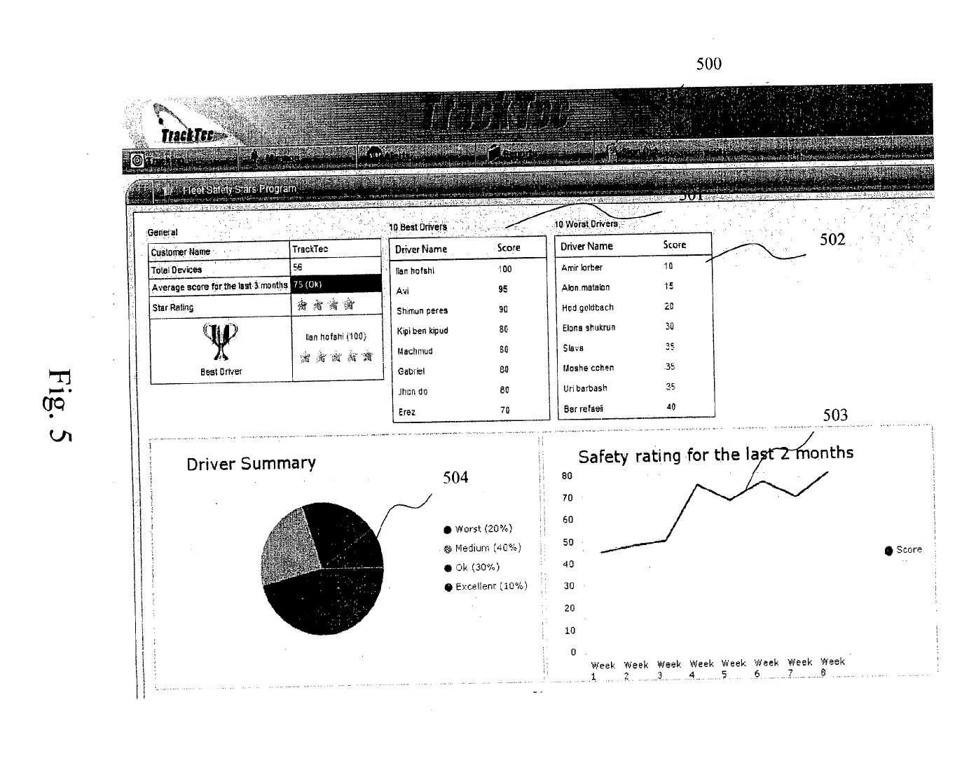

It is further within provision of the system herein disclosed to provide a summary report for a fleet of drivers. In FIG. 5 a fleet report 500 is shown which summarizes fleet performance in several ways, including a list of best drivers 501 and their respective driving scores (as calculated on the 0-100 scale), and a list of worst drivers 502 and their respective driving scores (as calculated on the 0-100 scale). A pie chart 504 of the distribution of driver performance (e.g. on a quartile scale) is also given, as is a chart 503 of average driver performance over time.

One possible method of driver scoring is now explained. One of the main goals of collecting tracking data from driver is to evaluate the quality/safety level of each driver, which is accomplished here quantitatively by a means of a number between 0 to 100 percent. Drivers with higher scores represent better and safer driving performance. The score is normalized such that a score of 50 represents the average driver. The system is based on tracking information for each driver and counting specific events such as: exceeding the speed limit, high levels of acceleration or deceleration, high levels of brake use, rapid/frequent/un-signaled lane switching, proximity to other vehicles/lane divisions, and other similar events or situations tending to reflect the skill, safety, efficiency, and timeliness of a driver.

The scoring calculation is based on estimating the frequency of a set of events for each driver. The calculation assumes that for each event type, the statistical distribution of such events is known. The statistic distribution may be decided by estimation, reference to literature values, and by directly compiling data from real cases.

Let N be the number of different event types identified in the system. Let symbol E represents the group of all possible events, denoting each event type by subscript i such that

E={E₁, E₂, . . . E_{N}}

The events are those of interest for analysis of driving performance (as pertaining to safety, time efficiency, fuel efficiency, and the like). Thus the following would generally be ‘interesting’ events to log: accelerations (e.g. above a certain threshold, or the entire histogram), decelerations, insufficient headway, insufficient clearance, signal use, lack of signal use during turns, velocity excursions, driver use of cellular phone, driver inattention, etc. Various other events of interest for various applications will be obvious to one skilled in the art.

The frequency of each event for a specific driver is denoted by the letter C:

C={C₁, C₂, . . . C_{N}}

We calculate a probability density function Pi(x) for each event. This function represents the probability of event i to have X occurrences. The probability function is normalized such that:

∫Pi(x)dx=1

Now we can define the cumulative probability function

$$F ( x ) = {\int }_{- ∞}^{x} Pi ( u ) d u$$

We attach a grade value for each event:

Gi=F(Ci)

for “positive” events where more such events indicates a better driver.

Similarly,

Gi=1−F(Ci)

for “negative” events where more events indicates a worse driver.

Furthermore we define a significance for each event type:

S={S1, S2, SN}

The Driver score is denoted by D and calculated in light of the previous definitions by:

$$D = {\sum }_{i = 1}^{ N} {G}_{i} ( {C}_{i} ) \times {S}_{i}$$

In one embodiment of the invention a special hardware device is provided dedicated to driver profiling, diagnostics and behavior modification. This device provides feedback directly to the driver allowing him to learn from mistakes and improve driving habits, conform to company specifications, and the like. Additionally, the device continually sends driver behavior information and associated data to one or more data collection stations by means of wireless connectivity, or by recording for later download, or the like.

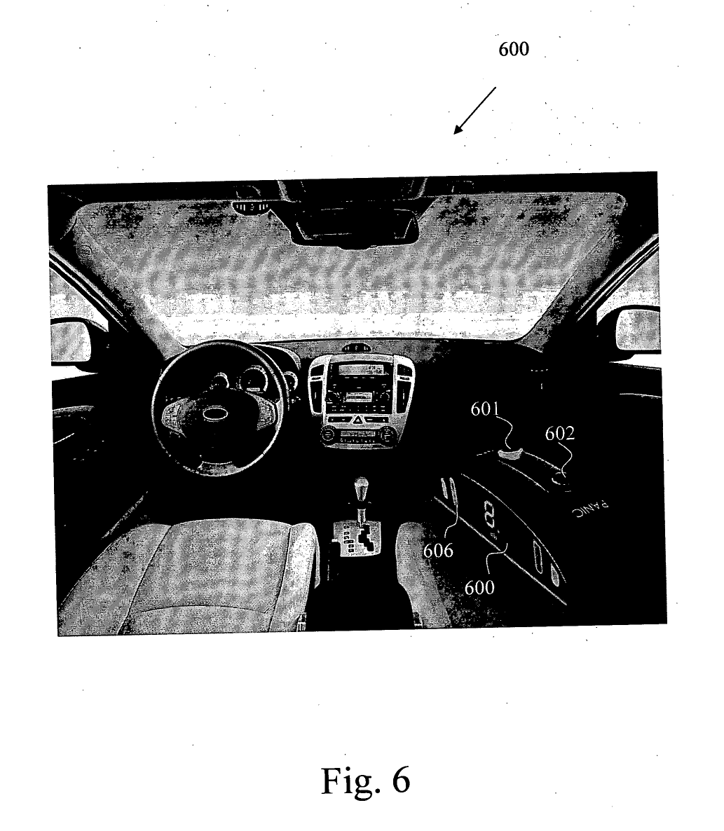

One implementation of this embodiment is shown in FIG. 6. The device 600 has an on/off button 601 and panic button 602 on its top surface, and a series of indicator lights 606. The device functions in two modes:
1. Real-time audio-visual display/alerts/signals to increase driving behavior awareness of the driver;
2. Status/Profile display based on database history to inform the driver of his/her driving patterns.

The unit is equipped with a panic button 602, which is an additional feature in our general application, not necessarily applicable to the profiling or status issues.

The On/Off button 401 simply turns off the display, but not the data transmissions. Thus if the indicators disturb the driver, he can neutralize them, but still remain monitored, and see his status when he turns it back on again.

The device is also shown in top, side, and bottom views 603,604,605.

The indicator lights 606, which may for instance be Red, Yellow, Green and Blue LEDs, are designed to light in proportion to accelerometer readings.

For example, if a driver pulls a very hard right turn, the LEDs on the right side of the display will become lit in turn, reaching the red markers. A moderate turn is indicated by yellow LEDs, while green and blue LEDS indicate acceleration within safe driving allowances. Similarly, left turns will light up the left side. For forward or backward g-force, both sides light up simultaneously.

Further indicators can be provided such as a “Status” LED, showing a constant display of one's driving status as it rates against safe driving standards and based on your driving history.

A good driver will not accumulate high-g-force events in the database and therefore the status indication will generally be blue or green. If the driver is moderately safe the Yellow LEDs will be lit more often than is considered safe, so his/her status may rise up to Yellow. Likewise, if the driver goes into the Red LEDs too often, the calculations in the database will change his status to Red.

The driver therefore can “see” both his/her actual behavior reflected back to him, in real-time events with lights and sound as well as a historical profile of his driving habits.

Calculation of fuel efficiency can be accomplished by means well known in the art, for example by direct computation of change in fuel level divided by distance traveled, by model-based computation based e.g. on an aerodynamic model of the vehicle and an efficiency model of the engine, by means of a table look-up, or the like. Such models will generally take into account the velocity as a function of time, allowing for computation of accelerations and decelerations.

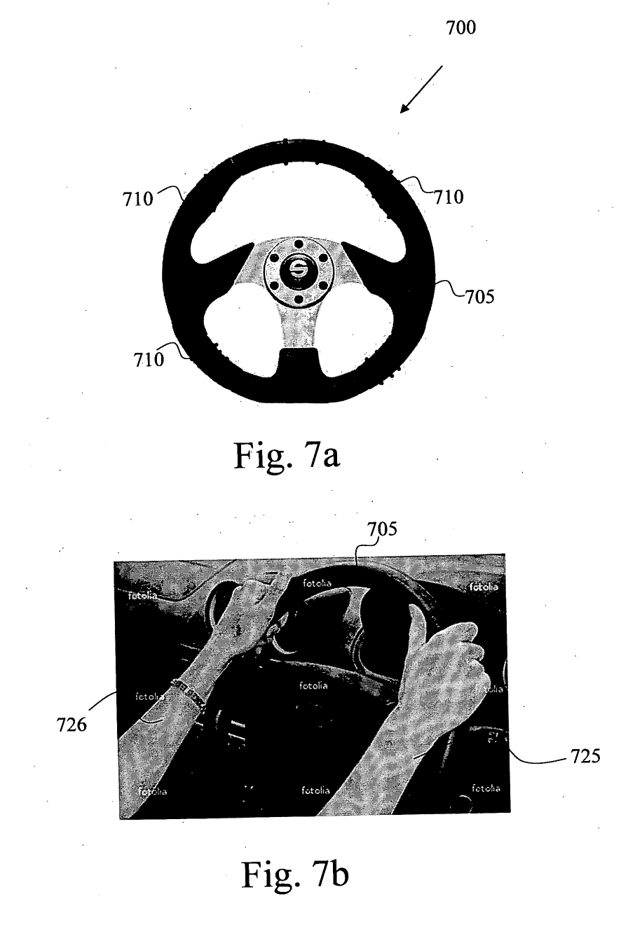

Reference is now made to FIGS. 7a-b which illustrate one example of an embodiment 700 of a steering wheel 705 according to the present invention. According to this embodiment, steering wheel 705 comprises at least one sensor 710 embedded therein. Sensor 710 is adapted to provide information which relates to the hold of steering wheel 705 and the time function of the hold of steering wheel 705. The sensors may be in any position along the steering wheel or along the complete steering wheel.

According to this embodiment, sensors 710 are adapted to indicate the following:
a. If the driver is holding steering wheel 705;
b. If the driver is holding steering wheel 705 while using both hands 725 and 726 (a firm hold);
c. It the driver is holding steering wheel 705 while using one hand 725 or 726 (minor hold);
d. If the driver is not holding steering wheel 705 at all; and,
e. The time function of the hold of steering wheel 705 (i.e., the amount of time the driver is holding the wheel with two hands, one hand, no hands at all).

Preferably, as illustrated in FIG. 7a, sensors 710 are positioned on preferred and predetermined location on the steering wheel 705. According to other embodiments, sensors 710 may be positioned at any other location which may indicate the parameters disclosed above.

By using the system of FIGS. 7a-b, the variation of the hold of steering wheel 705 vs. time can also be taken into consideration in the analysis of the driver characteristics.

1. A driver profiling system comprising:
a. at least one sensor adapted to measure vehicle parameters;
b. computing means in communication with said sensors, provided with storage means adapted to store said vehicle parameters, and provided with means for issuing warnings based on said vehicle parameters; and,
c. a remote server adapted to receive, store, analyze, and display said vehicle parameters;
d. communication means adapted to transfer said vehicle parameters and associated data to said remote server;
whereby historical vehicle parameter data may be analyzed to identify driver characteristics.

2. The system of claim 1 further comprising a display means within said vehicle adapted to display a plurality of parameters to said driver, said parameters selected from a group consisting of: acceleration level, deceleration level, headway distance, lane departure warning, fuel efficiency, time efficiency, and driving status.

3. The system of claim 1 wherein said driver characteristics are evaluated by determining a driver score D for every driver, based on frequencies Cᵢ of driving events i, such that
$$D = {\sum }_{i}^{ } {G}_{i} ( {C}_{i} ) \times {S}_{i}$$
with Sᵢ being a set of weights, and the Gᵢ being functions of said frequencies Cᵢ.

4. The system of claim 2 wherein said driving events are selected from a group consisting of: lane departures, accelerations, decelerations, insufficient headway, insufficient clearance, signal use, lack of signal use during turns, and velocity excursions.

5. The system of claim 2 wherein said driver score is used to determine a number of ‘safety stars’ said safety stars being a rating on a scale of 1-5 stars.

6. The system of claim 1 wherein said at least one sensor is selected from a list consisting of steering wheel position sensor, wheel angle sensor, gas pedal position sensor, brake pedal position sensor, brake pad position sensor, clutch pedal position sensor, clutch position sensor, vehicle velocity sensor, acceleration sensor, position sensor, wheel rpm sensor, engine rpm sensor, gear shift position sensor, external light level sensor, vehicle light condition sensor, video cameras, neighboring car proximity sensor, neighboring car velocity sensor, neighboring object proximity sensor, neighboring car velocity sensor, wind velocity sensor, rainfall rate sensor, road condition, sensor, tilt sensor, roll sensor, yaw sensor, cabin noise level sensor, cabin audio signal sensor, gas tank fuel level sensor, speed limit sensor or any combination thereof.

7. The system of claim 1, wherein said sensor is adapted to provide information relating to at least one selected from a group consisting of the steering wheel hold, the steering wheel hold as a function of time, amount of pressure applied on the brake system, the amount of times the brake system is pressed, the road conditions, the amount of times the driver had changed lanes to pass another vehicle on the road is counted, distance being kept from neighboring vehicles, seat belt wear, fatigue of the driver, visibility conditions, amount of outside light, humidity, weather or any combination thereof.

8. The system of claim 1, using a video camera, where said computing means is provided with image processing means adapted to identify events and parameters selected from a group consisting of: lane departures, neighboring cars, trucks, motorcycles, mopeds, bicycles, pedestrians, and amount of headway.

9. The system of claim 1, wherein said warnings are selected from a list consisting of: lane departures warnings, headway warnings, and forward collision warnings.

10. The system of claim 1, wherein said remote server is adapted to present histograms of driver performance data and histograms of average driver performance data.

11. A method for driver profiling comprising steps of:
a. providing at least one sensor adapted to measure vehicle parameters;
b. providing computing and storage means in communication with said sensors;
c. measuring vehicle parameters by means of said sensors;
d. storing said measurements by means of said storage
e. issuing warnings based on said vehicle parameters;
f. providing a remote server adapted to analyze said vehicle parameters;
g. communicating said vehicle parameters to said remote server;
h. receiving, storing, analyzing, and displaying said vehicle parameters on said remote server;
whereby historical vehicle parameter data may be analyzed to identify driver characteristics.

12. The method of claim 11 further providing display means within said vehicle adapted to display a plurality of parameters to said driver, said parameters selected from a group consisting of: acceleration level, deceleration level, headway distance, lane departure warning, fuel efficiency, time efficiency, and driving status.

13. The method of claim 11 further determining a driver score D for every driver, based on frequencies Ci of driving events i, with
$$D = {\sum }_{i}^{ } {G}_{i} ( {C}_{i} ) \times {S}_{i}$$
with Si being a set of weights, and the Gi being functions of said frequencies Cᵢ.

14. The method of claim 11 where said driving events are selected from a group consisting of: lane departures, accelerations, decelerations, insufficient headway, insufficient clearance, signal use, lack of signal use during turns, and velocity excursions.

15. The method of claim 11 where said driver score is used to determine a number of ‘safety stars’ said safety stars being a rating on a scale of 1-5 stars.

16. The method of claim 11, additionally comprising the step of selecting at least one sensor from a list consisting of steering wheel position sensor, wheel angle sensor, gas pedal position sensor, brake pedal position sensor, brake pad position sensor, clutch pedal position sensor, clutch position sensor, vehicle velocity sensor, acceleration sensor, position sensor, wheel rpm sensor, engine rpm sensor, gear shift position sensor, external light level sensor, vehicle light condition sensor, video cameras, neighboring car proximity sensor, neighboring car velocity sensor, neighboring object proximity sensor, neighboring car velocity sensor, wind velocity sensor, rainfall rate sensor, road condition, sensor, tilt sensor, roll sensor, yaw sensor, cabin noise level sensor, cabin audio signal sensor, gas tank fuel level sensor, and speed limit sensor.

17. The method of claim 11, using a video camera, where said computing means is provided with image processing means adapted to identify events and parameters selected from a group consisting of: lane departures, neighboring cars, trucks, motorcycles, mopeds, bicycles, pedestrians, and amount of headway.

18. The method of claim 11, additionally comprising the step of selecting said warnings from a list consisting of: lane departures warnings, headway warnings, and forward collision warnings.

19. The method of claim 11, where said remote server is adapted to present histograms of driver performance data and histograms of average driver performance data.

20. The method of claim 11, additionally comprising the step of providing information relating to at least one selection from a group consisting of the steering wheel hold, the steering wheel hold as a function of time, the time function of the steering wheel hold; amount of pressure applied on the brake system, the amount of times the brake system is pressed, the road conditions, the amount of times the driver had changed lanes to pass another vehicle on the road is counted, distance being kept from neighboring vehicles, seat belt wear, fatigue of the driver, visibility conditions, amount of outside light, humidity, weather or any combination thereof.
